(19) United States
(12) Patent Application Publication
(10) Pub. No.: US 2025/0276313 A1
(43) Pub. Date: Sep. 4, 2025

(54) MICROFLUIDIC CHIP

(71) Applicant: AtlasXomics Inc., New York, NY (US)

(72) Inventors: Zev KARTIGANER, Easton, CT (US); Gumaro ROJAS, New Haven, CT (US); Joseph C. GENNARO, New Haven, CT (US); Chen WANG, Somerville, MA (US)

(21) Appl. No.: 18/854,486

(22) PCT Filed: Apr. 5, 2023
(86) PCT No.: PCT/US2023/017615

§ 371 Date: Oct. 4, 2024

Related U.S. Application Data
(60) Provisional application No. 63/328,195, filed on Apr. 6, 2022.

(51) Int. Cl. B01L 3/00

(52) U.S. Cl. CPC B01L 3/502707; B01L 2200/027; B01L 2300/0819; B01L 2300/0861; B01L 2300/0887; B01L 2300/123; B01L 2300/16

(57) ABSTRACT

Present methods for delivering reagents to substrates using microfluidics chips suffer from an unnecessarily large exposure area with inactive regions of the substrate. Herein we describe a number of different microfluidic chip configurations that reduce the exposure area between liquid and substrate in inactive regions of the substrate. Doing so reduces the vulnerability of the reagent delivery system to dust and debris, as well as minimizing reagent waste due to interactions between the liquid reagent to be delivered and inactive regions of the substrate.

### CROSS-REFERENCE TO RELATED APPLICATIONS

This application claims priority to U.S. Provisional Patent Application 63/328,195, entitled “MICROFLUIDIC CHIP,” filed Apr. 6, 2022. The contents of which are incorporated herein by reference in their entirety.

### FIELD

The present disclosure relates generally to a configuration for a microfluidic device. In particular, the microfluidic device is configured to minimize the area of fluidic channels of the microfluidic device being exposed when placing a sample within the microfluidic device.

### BACKGROUND

Microfluidic chips are often employed in tissue sample analysis. These microfluidic chips allow for the introduction of precise amounts of reagent with a tissue sample. Unfortunately, many existing microfluidic chip designs used for tissue sample analysis are susceptible to contamination when adding the tissue sample into the microfluidic chip or removing the tissue sample from the microfluidic chip. This susceptibility to contamination generally means that a laboratory would be forced to spend a lot of time cleaning microfluidic chips before being able to add new tissue samples to the microfluidic chips. For this reason, microfluidic chips with lower susceptibility to contamination are desirable.

Therefore, it would be of significant benefit to practitioners of the art to develop an improved chip and method which can achieve consistent and high-quality interfacing of liquid with a substrate, with as little regard for the presence of dust and/or debris in the work area as possible, and while minimizing unwanted interaction between substrate and active components of the reagent to be delivered.

### SUMMARY

This disclosure describes a microfluidic chip configured in a manner that minimizes the likelihood of channels of the microfluidic chip being contaminated when placing a sample in the microfluidic device.

A sample analysis chip is disclosed and includes at least a sample interface layer, the sample interface layer defining a plurality of sample interface channels configured to guide reagents across a region of a sample that is in contact with the sample interface layer, the plurality of sample interface channels comprising a first sample interface channel and a second sample interface channel; and a loading/unloading layer in direct contact with the sample interface layer, the loading/unloading layer defining a plurality of inlets configured to receive the reagents at an exterior of the sample analysis chip, the plurality of inlets comprising a first inlet and a second inlet; a plurality of loading channels, comprising a first loading channel being configured to receive a first portion of the reagents from the first inlet and deliver the first portion of the reagents to a first end of the first sample interface channel and a second loading channel configured to receive a second portion of the reagents and deliver the second portion of the reagents to a first end of the second sample interface channel; a plurality of outlets configured to receive the reagents at the exterior of the analysis chip after being guided across the region of the sample, the plurality of outlets comprising a first outlet and a second outlet; and a plurality of unloading channels, comprising a first unloading channel configured to receive the first portion of the reagents from a second end of the first sample interface channel and guide the first portion of the reagents to the first outlet and a second unloading channel configured to receive the second portion of the reagents from a second end of the second sample interface channel and guide the second portion of the reagents to the second outlet. An active area ratio of the sample analysis chip is greater than 0.25%.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIGS. 1A-1D show exemplary microfluidic device configurations and how debris effects performance of the exemplary microfluidic device configurations.

FIGS. 2A-2D show top views and a side view of a microfluidic device in accordance with the described embodiments.

FIG. 3 shows a black and white photograph of a microfluidic chip with the configuration illustrated in FIGS. 2A-2D.

FIG. 4 shows another black and white image illustrating a mechanism for securing the microfluidic chip 300 shown in FIG. 3 in place during operations.

FIGS. 5A-5B show differences between exposure area and active area for single layer microfluidic chips and microfluidic chips configured in accordance with the described embodiments.

FIGS. 6A and 6B depict a design for and an example of a single-layer chip with 50 channels.

FIGS. 7A-7C show a two-layer chip design configured in accordance with the described embodiments.

FIGS. 8A-8C show a millifluidic chip including three physical layers formed of different materials and in accordance with the described embodiments.

FIG. 9 shows a cross-sectional view of a three-layer device that includes a loading/unloading layer, a transfer layer and a sample interface layer.

FIGS. 10A-10G display how multiple inlets can converge into a single outlet, thus making a denser design (defined as more channels in the region of interest without increasing the size of the chip).

### DETAILED DESCRIPTION

Certain details are set forth below to provide a sufficient understanding of various embodiments of the invention. However, it will be clear to one skilled in the art that embodiments of the invention can be practiced without one or more of these particular details. Moreover, the particular embodiments of the present invention described herein are provided by way of example and should not be used to limit the scope of the invention to these particular embodiments. In other instances, hardware components, network architectures, and/or software operations have not been shown in detail in order to avoid unnecessarily obscuring the invention.

Microfluidic chips deliver reagents from a microfluidic inlet to a tissue sample in a “Region of Interest” (ROI), also referred to as an active area of the substrate. In the active area the tissue sample is precisely contacted with liquid reagents. In some chip configurations the liquid reagents to be delivered interact with all areas of the tissue substrate along the way from inlet to the active area, including non-active areas.

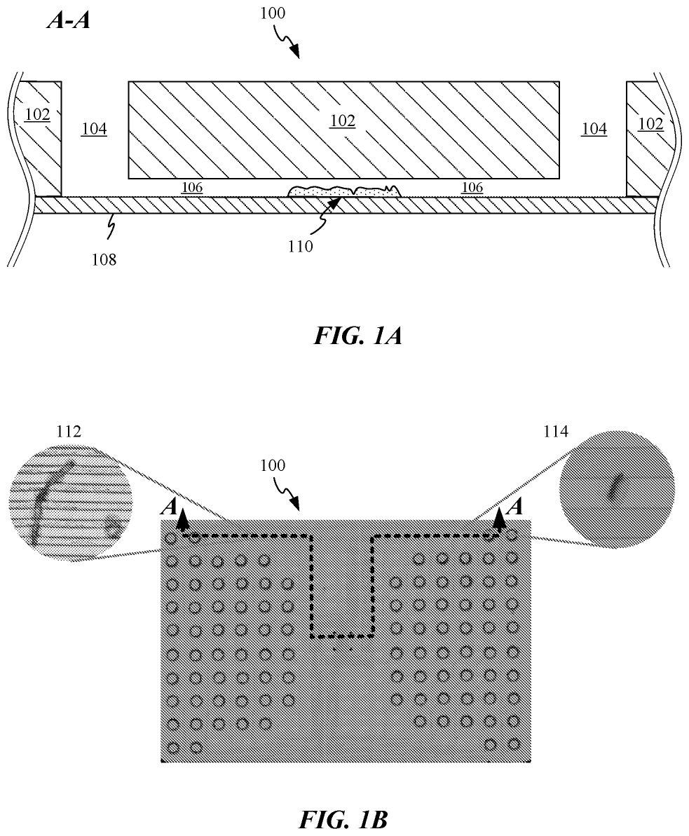

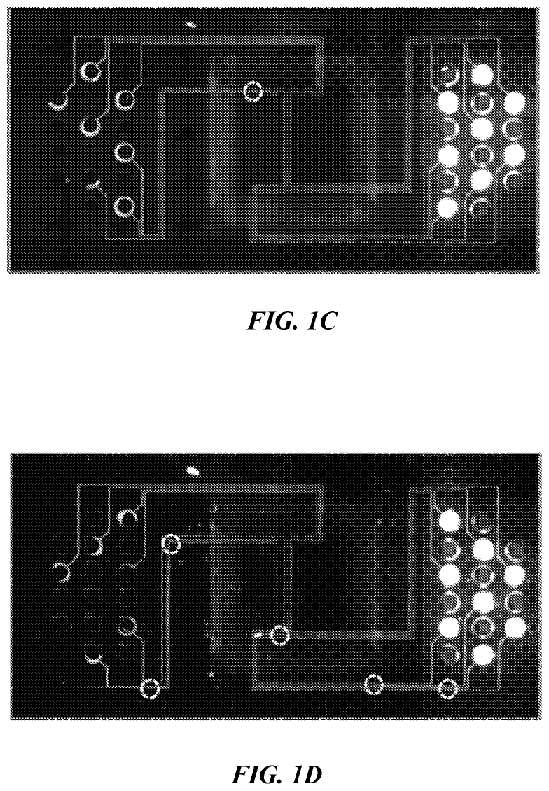

This configuration is depicted in FIGS. 1A-1B. As depicted in FIG. 1A, microfluidic chip 100 is formed of a single layer 102 that defines inlets and outlets 104 that lead directly into sample interface channels 106, which are also defined by single layer 102. Because reagent introduced into microfluidic chip 100 at inlets 104 comes into immediate contact with substrate 108 debris located almost anywhere on substrate 108 or on a substrate-facing surface of single layer 102 can interfere with and/or block the flow of reagent as it flows into and out of sample 110. This undesired exposure area is a consequence of a single-layer chip providing a macro-micro interface between the macroscopic scale (human interaction) and the microscopic scale (cellular-resolution chip features in the ROI). This large exposure area has at least two significant drawbacks for chips which aim to bridge the gap from the macro to the cellular or smaller resolution.

First, debris on glass slides in non-active areas can interfere with such open channels in microfluidic chips and can disrupt normal flow, including by blocking flow entirely in some channels, or induce improper communication (also referred to as leakage) between channels. FIG. 1B shows some examples of debris (dust, fibers) outside the active area (in the center of the pictured chip) interacting with sample interface channels in magnified images 112 and 114. This debris is likely to cause blocks or leaks if the pictured chip were used to flow reagents across a sample. It is very uncommon, in the typical lab setting, to assemble a chip and slide without at least some debris of the type pictured here even when following strict cleaning procedures.

FIG. 1C and FIG. 1D show another exemplary microfluidic chip with 16 inlets and outlets. These images show examples of crosstalk between sample interface channels caused by problematic debris falling between the sample interface channels and the coated glass substrate in a trial run performed without excessive cleaning of both surfaces prior to chip operation. The problematic debris is illustrated by the white dashed circles shown in FIGS. 1C and 1D.

Another problem with the exemplary microfluidic chips shown in FIGS. 1A-1D is unnecessary interaction between a reagent flowing through the microfluidic chip and the substrate 108 can interfere with the desired reaction between the reagent and substrate 110 in the sample area, for example by consuming active barcodes.

The active barcodes are a component of the reagent to be delivered by the microfluidic chip to the sample where they interact with a particular analyte or group of analytes. An analyte is a target entity or class of entities of interest to a practitioner utilizing the microfluidic devices described herein. Analytes and active barcodes may each be biological or non-biological or some mix thereof. In some cases the active barcode is an oligonucleotide designed to bind to analytes, which can be nucleic acids (such as fragments of DNA or RNA or other nucleic acids). In some embodiments, the active barcode is an antibody and the analytes are proteins. Biological analytes can take the form of modified nucleic acids (such as methylation sites), components of chromatin (such as accessible regions of DNA, or one or more of the various histones or other proteins which determine the conformation of DNA in nuclear chromatin), enzymes, single-cellular organisms such as bacteria, viruses, or any other biological entity or component of a biological entity. Active barcodes in these contexts could refer to antibodies, aptamers, or other small molecules, or any other component of the liquid that binds specifically to the analyte(s). In non-biological contexts analyte could also refer to an elemental, chemical, or molecular species, a certain repeating structure (such as fibers in a paper, pore openings of a certain size or shape in a gel or other polymeric matrix), or any other unique feature of a sample assayed using such microfluidic chips.

Interaction between poly-L-lysine coated glass (often used to form substrate 108) and reagents in the channels (specifically, oligonucleotides) can result in unwanted capture of the oligonucleotides by the poly-L-lysine, effectively reducing the amount of reagent available for reacting with the sample. As a result, excess reagent is required to be delivered into the inlets to provide sufficient reagents at the ROI, and results in higher reagent consumption and experimental costs.

The chance of debris disrupting flow can be reduced, but not eliminated, by time-consuming repeated manual cleaning of chip and slide. Cleaning the slide may also put tissue at risk due to repeated attempts at assembling the chip and slide. Depending on environmental conditions, since the chip and slide are both exposed to the environment during cleaning, it is possible to add as much debris as is removed in each cleaning step, thereby providing a minimum average level of debris, no matter how many cleaning steps are performed. Also, each cleaning step risks directly damaging the tissue (e.g., by inadvertently touching it with a gloved finger or adhesive). Debris that falls directly on tissue or other direct damage may irrevocably impair the quality of the subsequent experiment, since it is difficult to remove debris from many samples, including fixed tissue.

Alternatively, the method can be carried out in a dust free area such as a clean room. Such facilities are expensive to build and maintain. Requiring performance of the technique in such facilities would limit the scope of the previously described methods to those operators with access to such specialized facilities. Even so, small amounts of debris still present at various amounts in many clean rooms still has the potential to deteriorate experimental quality.

To limit interaction between reagents and substrate outside the ROI, the ROI could be shielded (e.g., with adhesive tape or a slab of PDMS) and a blocking agent (such as BSA) could be applied to non-ROI regions bearing PLL coating. The BSA could de-activate the PLL by chemically binding to it and preventing subsequent unwanted oligonucleotide capture. However, doing so could have unpredictable effects on the sealing behavior between substrate and chip when, for example, the substrate is glass and the chip is composed of PDMS, and further represents additional time and effort that must be expended to successfully operate the chip.

Another approach addressing a different aspect of unwanted capture is chip coating. To limit capture of active reagents such as oligonucleotides by the outer surfaces of the reagent-bearing channels of the chip, it is possible to coat the surfaces with a variety of substances, or to incorporate additives into the base material comprising the chip before chip fabrication. One example of this technique is to incorporate PEG-PDMS into polydimethylsiloxane (PDMS) before casting the PDMS during soft lithography (as in Gokaltun et al 2019¹). The resulting chip can be primed by treating with water or other primers, and after such priming exhibits lower adhesion to reagents such as cells or oligonucleotides. Such treatments provide additional potential benefit as the path lengths of microfluidic channels (and therefore surface area for potential capture of active reagents) grow relative to the area of the sample to be treated with reagent, and also as the concentration of active reagents (and therefore the rate of capture by chip surface area) increases.

One solution to the aforementioned problems is the use of novel chips and techniques that limit interaction of the reagent to be delivered to only a portion of the substrate, rather than the entire exposure area between chip and substrate. Such chips have in common a separation between a loading/unloading layer and one or more sample interfacing layers. This separation retains the desirable feature of providing an easy-to-use interface between the macroscopic (humans with pipettes) and microscopic (cellular resolution) scales but without exhibiting excessively large interaction areas between reagents and non-sample areas of the substrate.

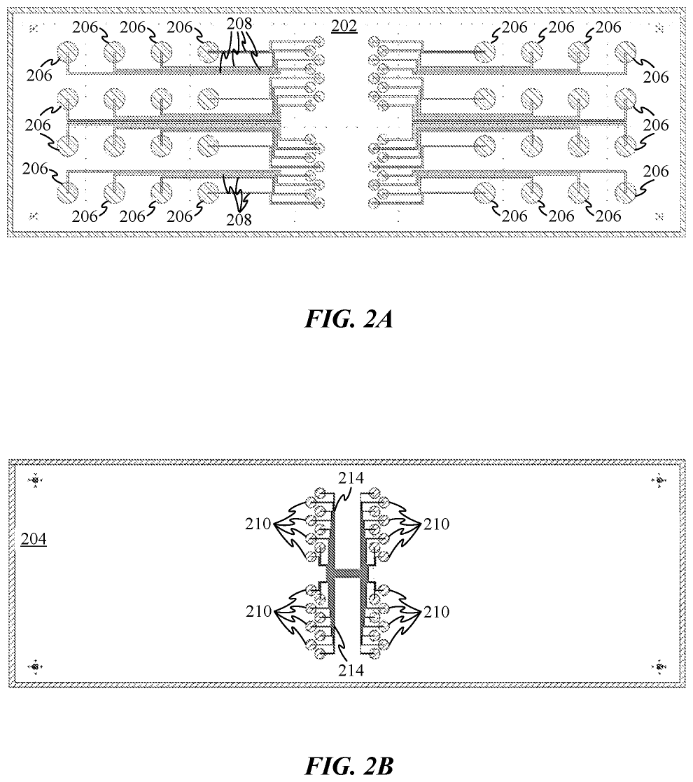

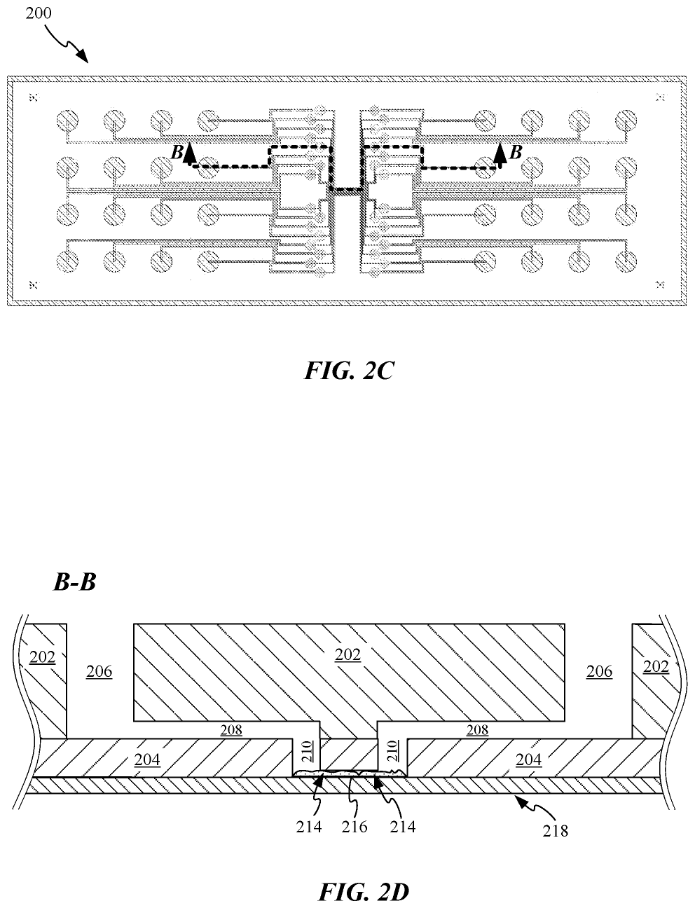

A simple exemplary abstract form of such a chip is shown in FIGS. 2A-2D. In the depicted configuration, liquid reagents delivered to inlets 206 are free to be drawn through corresponding continuous loading channels 208 to vertical via 210, then through sample interface channels 214 and across a sample 216 (in this case, a tissue section). In some embodiments the liquid is impelled via a vacuum-provided pressure gradient. In other embodiments the pressure gradient could be provided by a positive pressure source, such as a syringe pump, peristaltic pump (including finger-actuated pumps), diaphragm pumps, or any combination of a variety of fluid pumps known to those skilled in the art. Crucially, regions of sample interface layer 204 of the chip prevent the liquid from coming in contact with a substrate 218 in non-sample areas, thus removing the need to assiduously clean those areas prior to chip operation. This also prevents any active coatings on the substrate (such as PLL) from interacting with active ingredients in the liquid reagent (such as oligonucleotides), thus preserving them for interacting with sample 216 as intended by the chip.

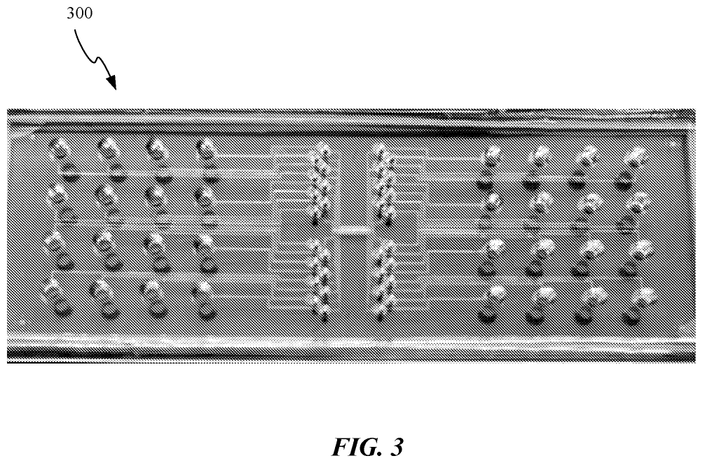

FIG. 3 shows a black and white photograph of a microfluidic chip with the configuration illustrated in FIGS. 2A-2D and provides a clearer idea of how an actual implementation of the disclosed embodiments appears.

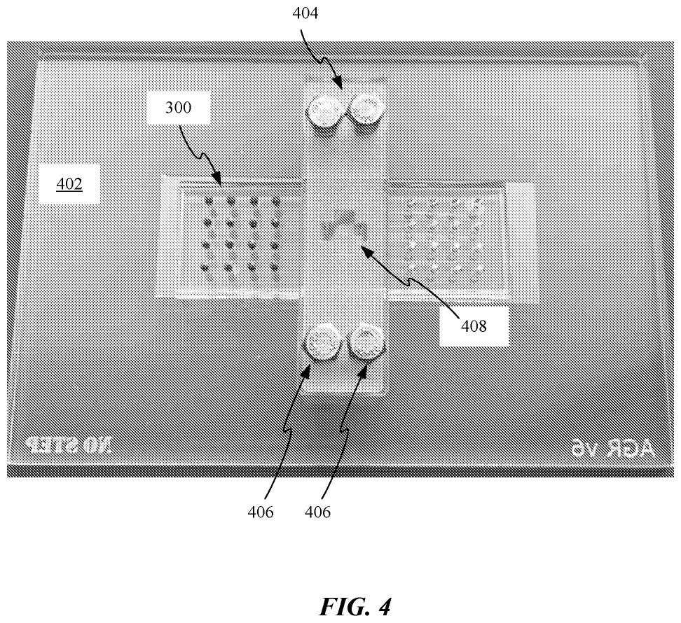

FIG. 4 shows another black and white image illustrating a mechanism for securing the microfluidic chip 300 shown in FIG. 3 in place during operations. In particular, FIG. 4 depicts a support structure 402 upon which the microfluidic chip 300 is supported. Support structure can be configured to attach to clamping structure 404, which includes fasteners 406 that secure clamping structure 404 to support structure 402. Fasteners 406 can be screwed down in order to apply a force to an upward-facing surface of microfluidic chip 300. The force applied to the upward-facing surface of microfluidic chip 300 keeps microfluidic chip 300 in place during use and also keeps the substrate and microfluidic chip pressed firmly together to prevent leakage between microfluidic chip 300 and the substrate holding a sample against microfluidic chip 300. The image in FIG. 4 also shows a clear cross-shaped region 408 left optically transparent so an area of the microfluidic device occupied by a sample can be visible during operation of the microfluidic device.

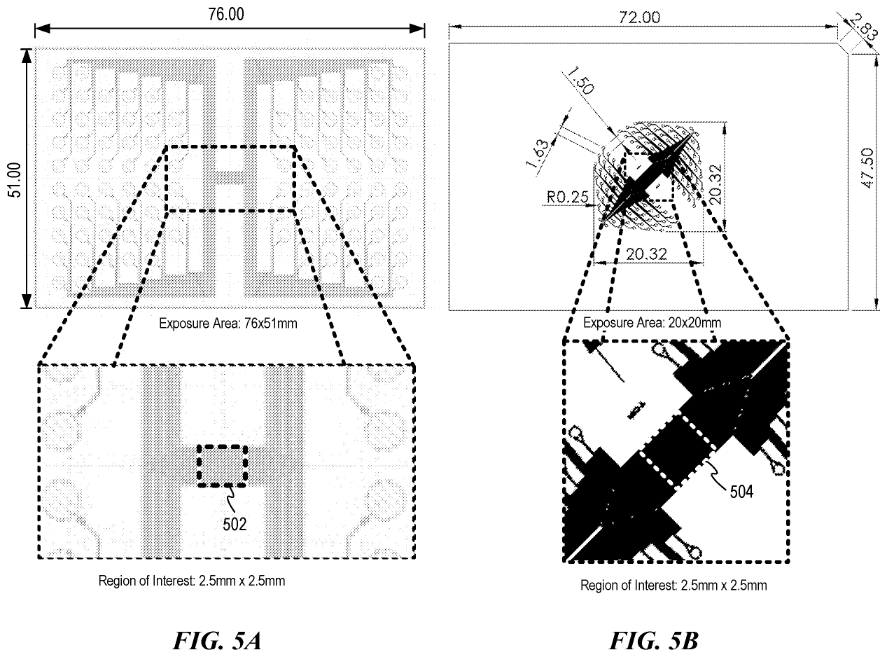

An area of exposure (“exposure area”) between microfluidic chip 200 or 300 and substrate 218 is defined as the minimum area enclosing chip features which allow liquid reagent and substrate to interact. In a single-layer chip, depicted in FIG. 5A, the exposure area is equal to the entire area of the chip and substrate (e.g., three square inches in a chip whose features fit on a 1″×3″ glass slide). In a chip designed according to the improvements described herein and depicted in FIG. 5B, the exposure area is limited to the reagent-bearing area of the sample interface layer only. Since both chips achieve the same goal of delivering reagent to the sample area of the substrate, the one that uses less exposure area will provide superior resistance to dust and debris and will suffer less reagent capture by non-sample areas of the substrate and will therefore provide superior performance and efficiency. The rates of capture of environmental dust and debris by a substrate and chip surfaces to be mated are directly proportional to the exposure area; the smaller exposure areas make chips easier to clean and keep free of contaminants. The same line of argument applies to active ingredient captured by substrate or substrate coatings; chips with smaller exposure areas waste less reagent.

To put the exposure area into context, it should be compared to the area of the smallest rectangle enclosing the subset of the sample which is subjected to reagent delivery. This is called the region of interest or active area and shown in FIGS. 5A and 5B by dashed boxes 502 and 504. The size of the region of interest is a key figure of merit for biological assays, since smaller regions of interest provide information about a smaller fraction of the sample to be assayed. Unlike microscopy-based assays which can image entire microscope slides by scanning the field of view across the entire slide, microfluidic-based assays have a region of interest limited to the region inside which they can deliver reagents in a spatially-determined manner.

To quantify this relative performance attribute the key figure of merit we use to compare chips in this method is the ratio of active area to exposure area, or the active area ratio (AAR). See FIG. 5B above which illustrates the exposure area and area of the region of interest for two chip designs, two-layer (left) and single-layer (right).

Chips with identically sized regions of interest but different exposure areas will have different AAR's. The chips with higher AAR's will perform better than chips with lower AAR's in terms of how frequently their flow is disrupted by contaminants or what proportion of active ingredient in the reagent is captured by the substrate during operation.

This could be measured by the relative average number of chip failures due to dust and debris, or the amount of reagent wasted due to capture by substrate instead of sample. Alternatively, it could describe the relative amount of time and care required to clean a single-layer chip to achieve the same performance as a multi-layer chip with smaller exposure area, or the relative amount of input reagent required to deliver a given amount of reagent to the sample itself.

Using this definition, chip AAR's range from zero to one, with the maximum value of one being achieved when the entire region of interest is also the exposure area. In practice, only a chip with reagents loaded from above with loading chambers of diameter equal to the microchannel widths could achieve a ratio of 1.

Below we exemplify designs that achieve a range of AAR's and present data consistent with the hypothesis that chips with higher AAR's perform better than chips with lower AAR's. Table 1 summarizes the AAR's we have achieved with these designs in comparison to a single-layer chip with a very poor AAR (0.16%) and the hypothetical, unrealized chip with 100% AAR.

TABLE 1
Comparison of Active Area Ratios (Assuming
Channel Width and Spacing are 25 μm)

| | | | | IMPROVEMENT |
|---|---|---|---|---|
| | EXPOSURE | ACTIVE | ACTIVE | OVER SINGLE- |
| | AREA | AREA | AREA | LAYER, 16- |
| DESIGN | (SQ MM) | (SQ MM) | RATIO | CHANNEL |
| SINGLE- | 1935 | 0.64 | 0.03% | — |
| LAYER 16- | | | | |
| CHANNEL | | | | |
| TWO- | 136 | 0.64 | 0.47% | 15.67x |
| LAYER 16- | | | | |
| CHANNEL | | | | |
| SINGLE- | 3871 | 6.25 | 0.16% | 5.33x |
| LAYER 50- | | | | |
| CHANNEL | | | | |
| TWO- | 400 | 6.25 | 1.5% | 50.0x |
| LAYER 50- | | | | |
| CHANNEL | | | | |
| MULTI- | 400 | 16 | 4.0% | 133.3x |
| MATERIAL | | | | |
| 80-CHANNEL | | | | |
| TWO-LAYER, | 400 | 23.04 | 5.76% | 192x |
| COMMON | | | | |
| OUTLET | | | | |
| 96-CHANNEL | | | | |

### Previous Single-Layer Embodiment: Single Layer, 50-Channel Configuration

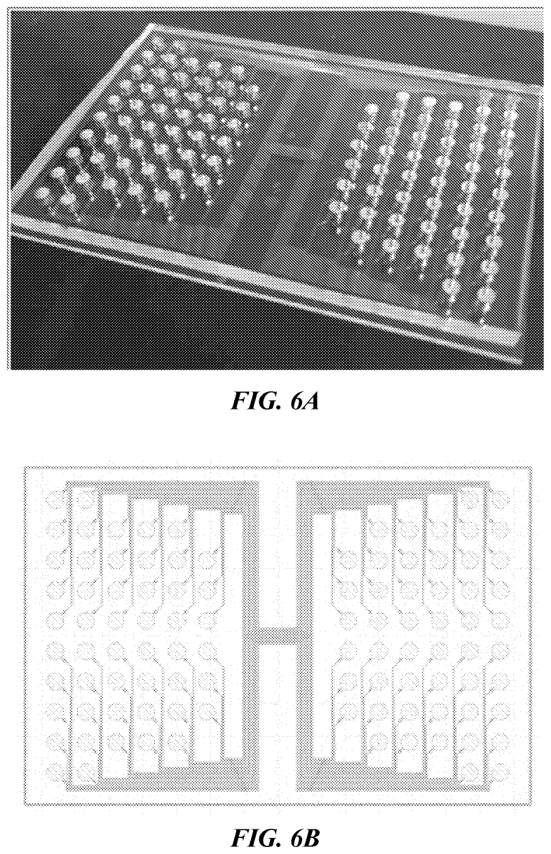

FIGS. 6A and 6B depict the design for and an example of the current single-layer chip with 50 channels, a region of interest of 2.5×2.5 mm composed of 50×50 25 um channels, yielding an active area ratio of 0.16%. While functional, doing so without multiple flow disruptions requires assiduous cleaning, often between 10 minutes and 1 hour of repeated cleaning, assembly, and inspection. The long assembly time and multiple steps put delicate samples at risk, such as tissue sections, both due to physical damage and to time- and temperature-related degradation.

Since the chip has only one layer, the exposure area of the chip consists of the rectangle enclosing all of the chip features, which by design is the same size as a 2″×3″ microscope slide.

### Multi-Layer Embodiment: Two-Layer, 16 Channel Configuration

FIGS. 2A-2D depict, as discussed previously, the multilayer design for an illustrative two-layer chip that demonstrates these principles. The chip's function is to interface manually-inlets and outlets for pipetted reagents (2.25 mm diameter) with 25 um wide microfluidic channels in the sample interface layer. As a proof-of-concept 16-channel chip, it produces an 800×800 um region of interest for a crossflow type experiment consisting of sequential applications of two such chips. Those skilled in the art will appreciate that the principle behind this proof-of-concept chip can be used to produce a more practically useful chip merely by adding more channels (and therefore a larger region of interest) which would be of more practical use; we describe such a more highly multiplexed chip below.

The loading/unloading layer 202 and sample interface layer 204 depicted in FIGS. 2A and 2B can be fabricated via standard soft lithographic techniques well known to those skilled in the art and are subsequently subjected to UV illumination in an ozone cleaner on the sides to be laminated together. The two layers are then aligned in a stereoscopic microscope, pressed together, and baked overnight at 80° C. in a convection oven. An image of one such resulting two-layer chip is shown in FIG. 3.

A single layer chip of this footprint would have an exposure area of the entire glass slide, or approximately three square inches (1935.48 sq mm). Meanwhile, this two-layer design's tissue interface layer has features that lie within a 17 mm×8 mm rectangle, or 136 sq mm. This gives an exposure area advantage of over 14 times (1935.48/136=14.23×) compared to the single layer chip. The region of interest of both chips is 2.5×2.5 mm, or 6.25 sq mm, yielding AAR's of 0.03% for the single-layer chip and 0.47% for the two-layer chip (see summary in Table 1).

Testing the Hypothesis that Decreased Exposure Area Improves Usability

We conducted an N=3 paired test to compare the performance of single layer vs. multilayer chips and test the hypothesis. The test itself involves clamping a chip to a sample-bearing glass slide, then loading the inlets with colored reagent such that when flowed, the channels in the region of interest will transport alternating red- and green-colored liquid reagent to the sample (see FIG. 4). After assembly the test procedure used vacuum pressure of approximately 100 inches of water to flow alternate-colored dyes across from the loading/unloading layer, through the tissue exposure layer, across the sample, then back out again. By imaging the sample in an epifluorescence microscope during and after flow, we were able to inspect the entire exposure area for blocked channels (defined as those in which liquid was unable to flow) and crossed channels (defined as those channels from which reagent improperly entered a neighboring channel). Both types of flow disruption seriously impair assays to be conducted using these chips, even in low numbers, therefore any incidence of flow disruption other than zero was considered a chip failure.

To perform the control trials, three single-layer sixteen channel chips with design very similar to the two-layer chip were fabricated with identical methods (except with no multi-layer bonding) and assembled onto an PLL-coated glass slide (custom fabricated by Scientific Device Laboratory, Chicago, IL) with a mouse embryo tissue (age E13, C57, Zyagen, San Diego, CA) section in the sample area. No cleaning of either surface took place prior to assembly.

TABLE 2

| | | NUMBER | |
|---|---|---|---|
| | | OF FLOW | |
| TRIAL | CONDITION | IRREGULARITIES | REASON |
| C1 | Single layer chip, | 2 | Leak due |
| | no cleaning | | to debris |
| C2 | Single layer chip, | 5+ | Multiple leaks |
| | no cleaning | | due to debris |
| C3 | Single layer chip, | 2 | Leak due |
| | no cleaning | | to debris |
| E1 | Two-layer chip, | 0 | n/a |
| | no cleaning | | |
| E2 | Two-layer chip, | 0 | n/a |
| | no cleaning | | |
| E3 | Two-layer chip, | 0 | n/a |
| | no cleaning | | |

To perform the experimental trials, we fabricated three 16-channel two-layer chips according to the procedure above and assembled them onto identical PLL-coated glass slides with same age and line mouse embryo tissue sections mounted in the sample area as in FIG. 4.

Table 2 summarizes the control and experimental results. In each of C1, C2, and C3, dust and debris resulted in multiple flow disruptions, (trial 1, two channels leaked with each other due to connection by dust particle; trial 2, many such leaks were observed; trial 3, two channels leaked with each other due to connection by dust particle; FIGS. 1C and 1D show images of the debris that caused the failures). In all three experimental trials using the two-layer chips, no flow disruptions occurred. These results are consistent with our hypothesis that by limiting the exposure area, we could reduce the number of flow disruptions.

### Two-Layer PDMS Chip

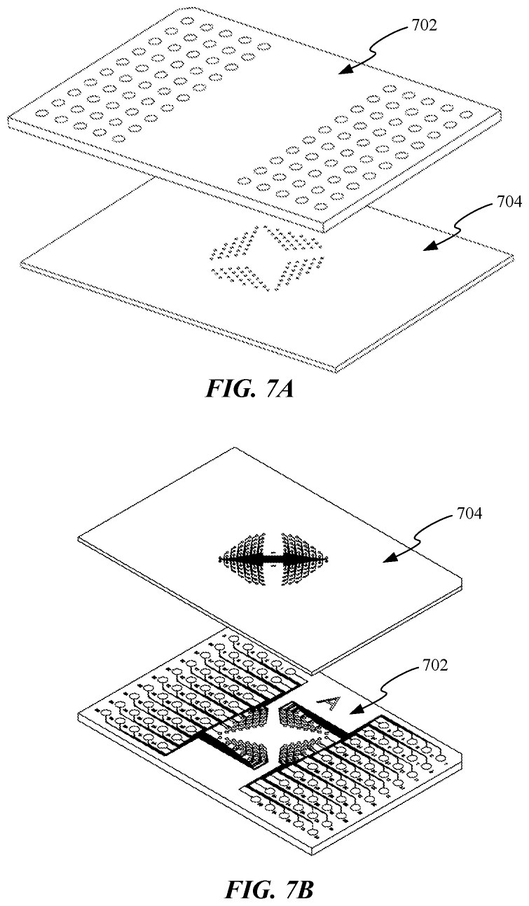

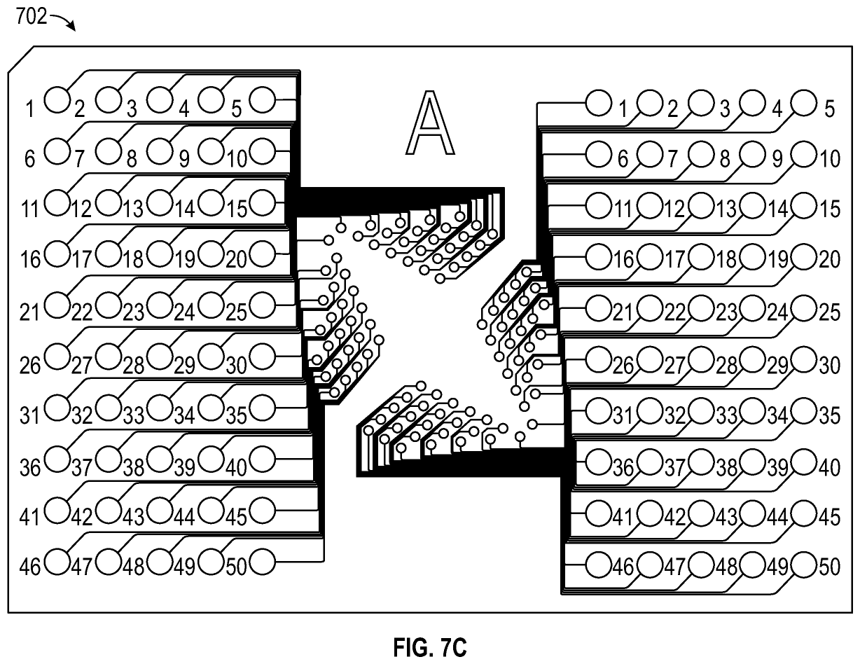

FIGS. 7A-7C show a two-layer chip design (where both layers can be made of PDMS) with a total footprint of 2″×3″ (3870.96 sq mm) and an exposure area of approximately 20×20 mm=400 sq mm. It features fifty microchannels with widths ranging from 100 um near the inlets and outlets to 25 μm in the region of interest, producing a region of interest on the sample spanning 6.25 sq mm, consisting of 2,500 detector elements with 25×25 um size and 50 um center-center spacing. The internal chambers (“vias”) connecting a loading/unloading layer 702 with a sample interface layer 704 have a diameter of 500 μm and center-center spacings between 1.50-1.63 mm. Meanwhile the inlet/outlet ports on loading/unloading layer 702 have a diameter of 2.25 mm and a grid spacing of 4.5 mm, which is consistent with 384-well PCR plates and therefore ensures compatibility with multi-channel pipettes and automated liquid handlers. This chip will be fabricated using standard soft lithography methods to cast each layer separately. Following inlet/outlet port coring, the two slabs will be ozone treated, optically aligned, then cured together to form a single chip.

Loading/unloading layer 702 has its inlets and outlets arranged in a 384-well PCR plate format, ensuring compatibility with multi-channel pipettes and automated liquid handlers for higher throughput and lower error rates than is achievable with manual single-channel pipetting.

The active area ratio of this two-layer PDMS chip is 6.25 sq mm/400 sq mm=1.5%. This is a substantial improvement over an equivalent single-layer chip with ratio of 6.25/3870.96=0.16% (See Table 1).

Another aspect relevant to maximizing the active area ratio (AAR) of this style of chip can be observed by comparing the arrangement inlet/outlet arrays in the loading/unloading layer with the arrangement of the vertical vias connecting the tissue interface layer to the loading/unloading layer. In the case of the external inlets and outlets, care is taken to place them on a grid conforming to the SBS PCR plate guidelines, which requires that the inlets and outlets are located on a square grid with 4.5 mm spacing center-center. This ensures compatibility with multi-channel pipettes and automated liquid handlers without increasing the exposure area, since the loading/unloading areas do not contribute to the exposure area. The vertical vias, on the other hand, define the outer limits of the rectangle circumscribing the exposure area and do not need to be interfaced with by pipette or liquid handler. We therefore invented an arrangement of the vias that maximizes the number of vias that can routed successfully from connection with the loading/unloading layer to the proper area of the region of interest without violating the diameter or center-center spacing constraints placed upon the tissue interface layer by soft lithographic manufacturing methods.

### Two-Layer Multi-Material Chip

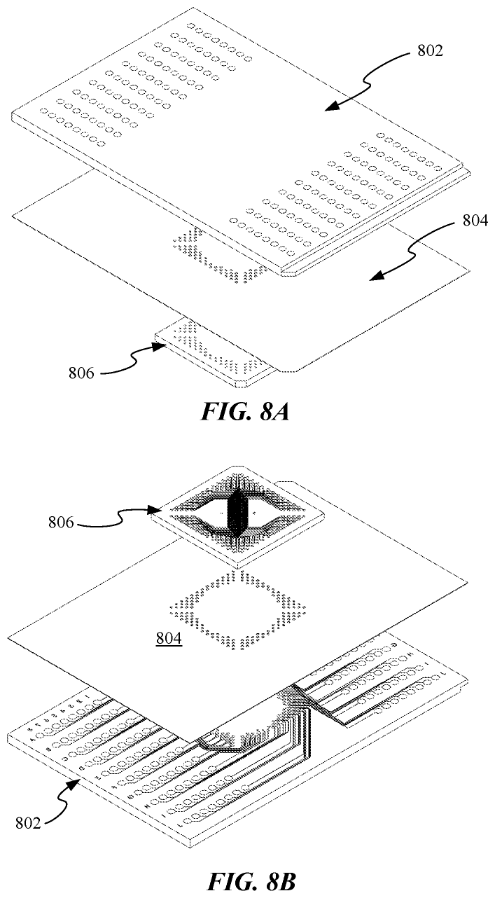

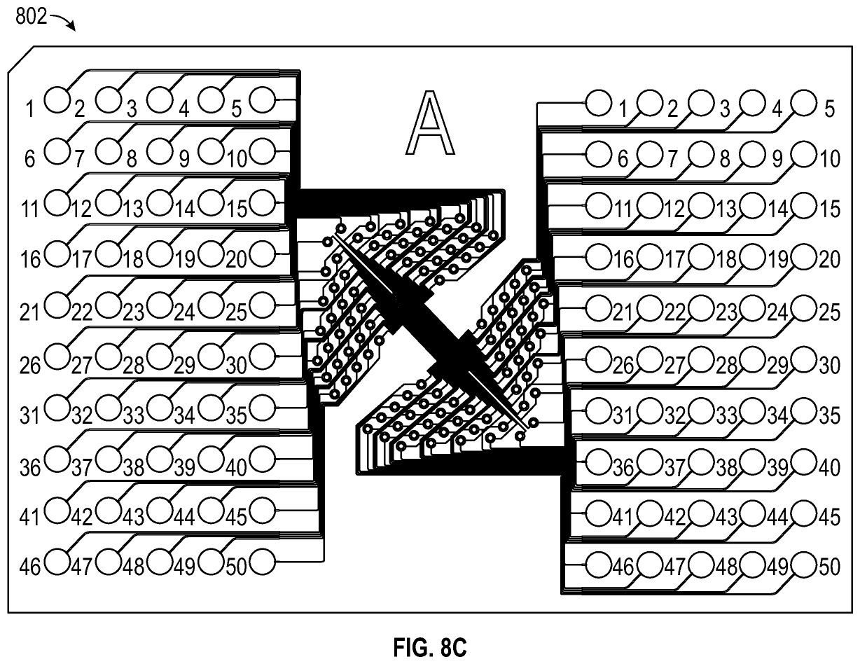

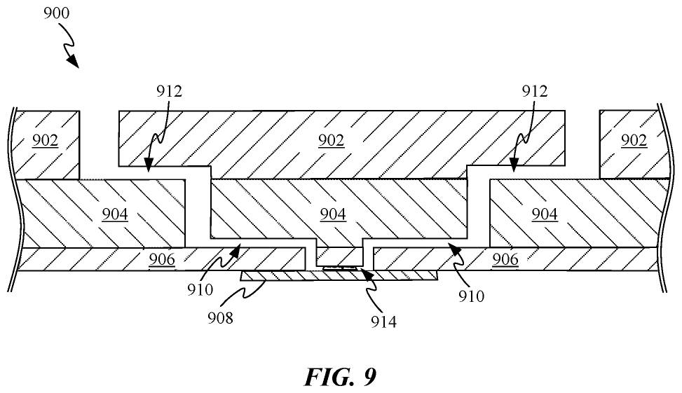

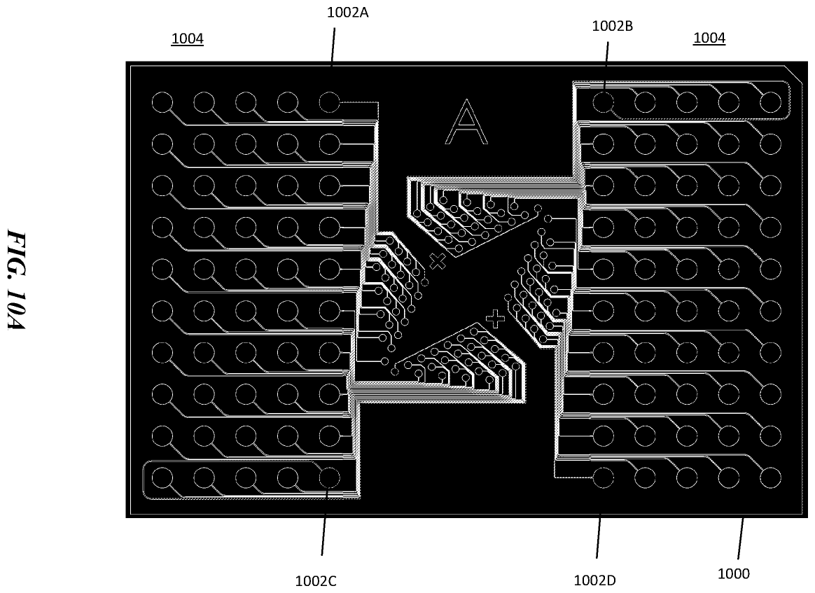

FIGS. 8A-8C show a mass-producible chip with three physical layers. The footprint of this chip is 2″×3″ and its exposure area is also approximately 400 sq mm. Its high density of inlet and outlet ports allowed us to fit 80 channels instead of 50 to achieve a larger region of interest spanning approximately 4×4 mm in the sample area. Thus its region of interest area (16 sq mm) divided by its exposure area (400 mm) is approximately 4%, which is an even greater improvement over the equivalent single layer chip with 50 channels of 25 um width in the region of interest on a 2″×3″ footprint (0.16%)—see Table 1.

This chip can be fabricated as follows. A loading/unloading layer 802 can be made of rigid plastic and fabricated via injection molding. A film layer 804 with a thickness of between about 0.25 mm and 1 mm can be adhered to loading/unloading layer 802 to provide a seal for the loading channels of loading/unloading layer 802, which lie outside the exposure area and defines cutout holes that align with respective ends of the loading channels of the loading/unloading layer 802 and vertical vias defined by sample interface layer 806. In some embodiments, films with other suitable thicknesses are used (e.g., film thicknesses greater than 1 mm or less than 0.25 mm). This layer can be fabricated by producing a thin film plastic layer and using laser ablation to cut away holes making up one or more pass-through areas. It should be noted that while FIGS. 8A and 8B depict openings generally corresponding to each of the vertical vias defined by sample interface layer 806, the openings in thin film layer 804 could also include larger openings corresponding to a subset or even all of the vertical vias defined by sample interface layer 806. Third, sample interface layer can be made of elastomeric material and provides tissue exposure. The sample interface layer receives and ejects liquid reagent through vertical chambers which pass through the thin film middle layer to communicate with matching microfeatures on the top loading/unloading layer. To keep the exposure area as small as possible, the vertical vias defined by sample interface layer 806 are designed to be small (500 um diameter) and dense (1.41 mm center-center spacing). This layer can be fabricated either using standard soft lithography methods or by injection molding using thermoplastic elastomers using techniques and methods known to those skilled in the art of injection molding. Following fabrication of all three layers, they can be optically aligned and bonded together using standard methods, including ozone treatment, solvent primers or adhesives, or other methods known to those skilled in the art (e.g., mechanically alignment).

As described with respect to the previous two-layer embodiment, an arrangement of vertical vias has been designed that allows placement of 160 vias (80 in, and 80 out) within a 20×20 mm exposure area without violating the diameter and spacing constraints imposed by the manufacturing process for the elastomeric tissue interface layer (either injection molding, soft lithography, or another method).

FIG. 9 shows a cross-sectional view of a three-layer device that includes a loading/unloading layer 902 a transfer layer 904 and a sample interface layer 906. An exposure area is the area of the smallest rectangle enclosing the features on an underside of the sample interface layer 906 and a surface of substrate 908 facing the underside of sample interface layer 906. Incorporating transfer layer 904 into the previous two-layer designs grants the designer freedom in gradually reducing the size of the microchannels connecting inlets and outlets to vertical vias communicating with the sample engagement layer. FIG. 9 illustrates this gradual reduction in channel size, showing that transfer channels 910 of transfer layer 904 are smaller than loading channels 912 and larger than sample interface channels 914.

In the event a clamp is necessary to ensure leak-free delivery of liquid reagents to the sample in the sample-engagement layer, an amount of pressure applied by such clamping mechanism might interfere with proper operation of microchannels in upper layers of the microfluidic device if the channels lie inside the clamped area. The transfer layer frees the designer to locate larger channels (which are more likely to be interfered with by clamping) near the inlets and outlets, medium size channels to connect large channels in the loading/unloading layer to small channels in the sample engagement layer, and smaller microchannels typical of the desired spatial resolution of the reagent delivery in the region of interest in the sample-engagement layer. This concept is not limited to one transfer layer. Indeed, those skilled in the art will recognize that there could be any number of transfer layers, with the thickness of each layer decreasing in proportion to the number of layers, such that in the limit where the thickness becomes very small and the number of layers very high, curved three-dimensional structures could be obtained, effecting advantageous shapes and curvatures of the sidewalls of the channels and vertical vias so as to minimize bubbles or other flow-interfering phenomena. Such a plurality of layers could be obtained by assembling a large number of single-layer slabs of PDMS fabricated by soft lithography, or by additive manufacturing methods such as 3-D printers, which function by successively adding thin layers of material to that material already deposited.

In some embodiments, transfer layer 904 can also operate as a loading/unloading layer when transfer layer 904 extends outbound of transfer layer 902.

Another method to improve the AAR is to increase the size of the active region. Practitioners largely benefit from increasing the region of interest (“ROI”). One method to increase the ROI is to increase the channel width. However, this can result in undesirable resolutions.

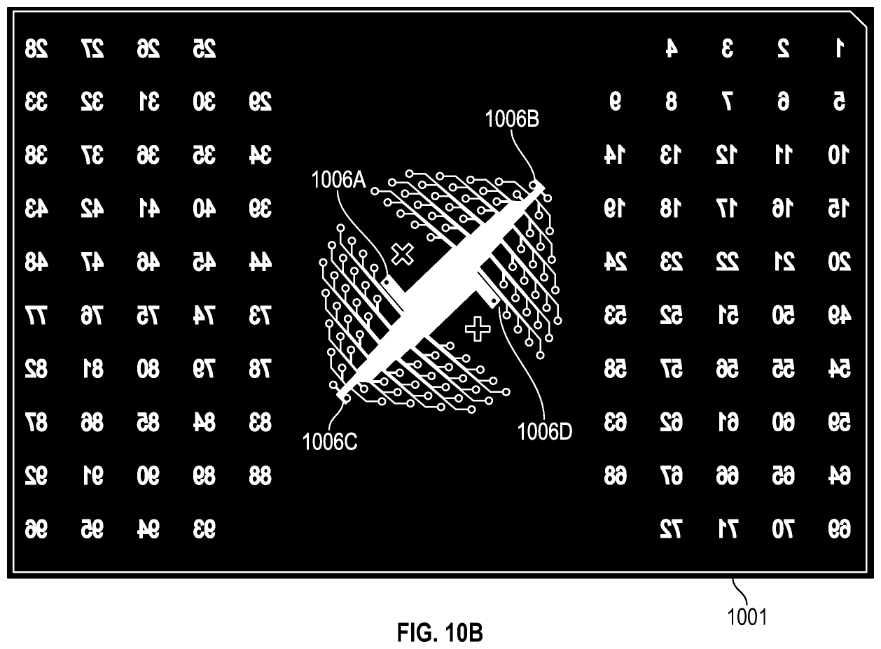

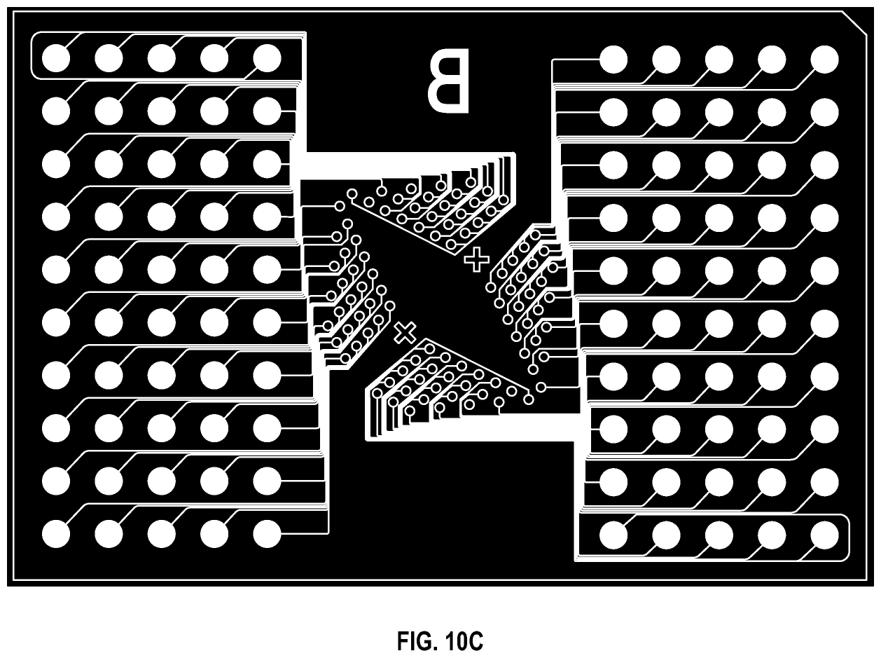

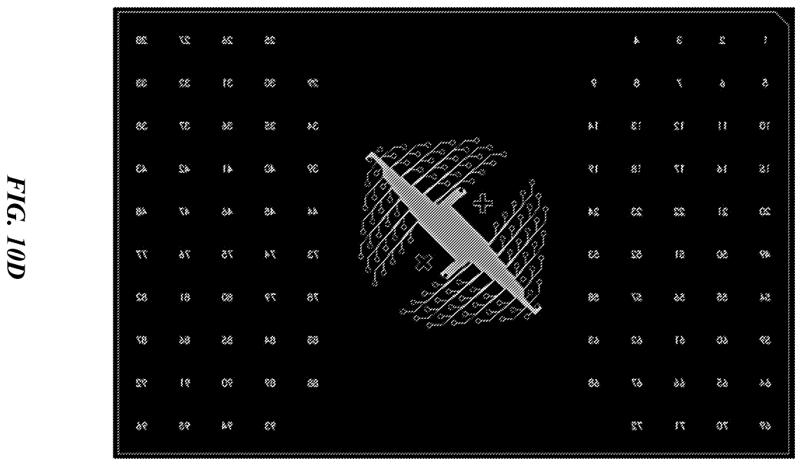

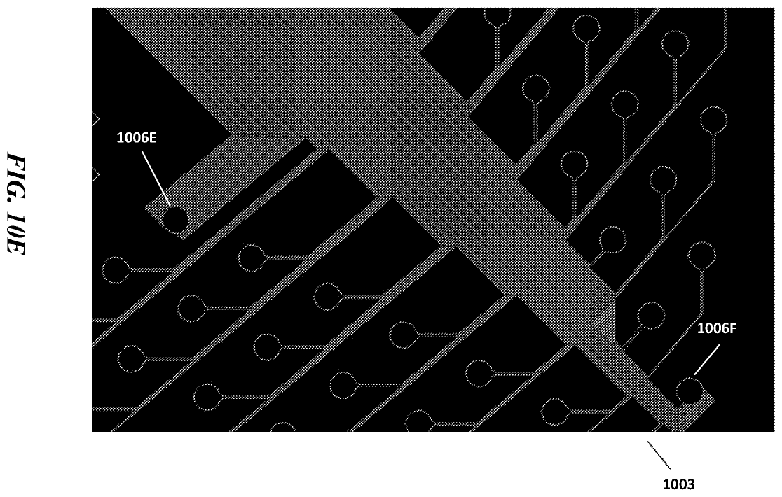

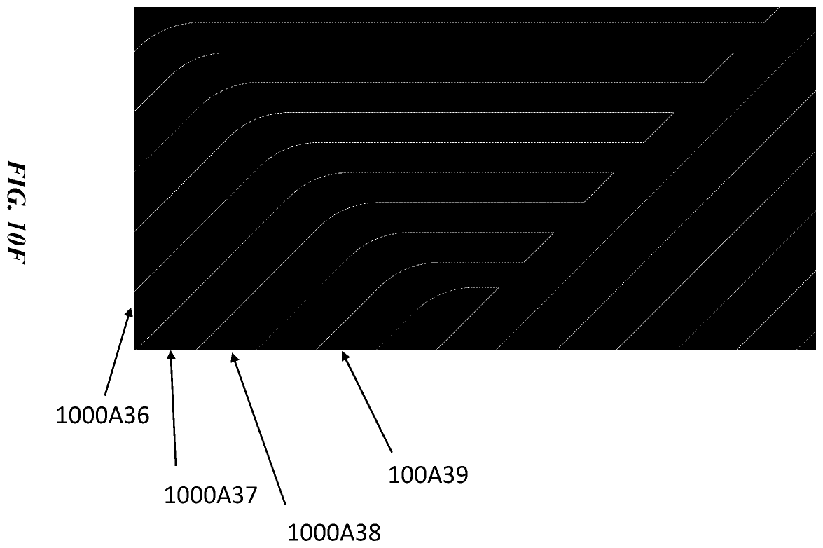

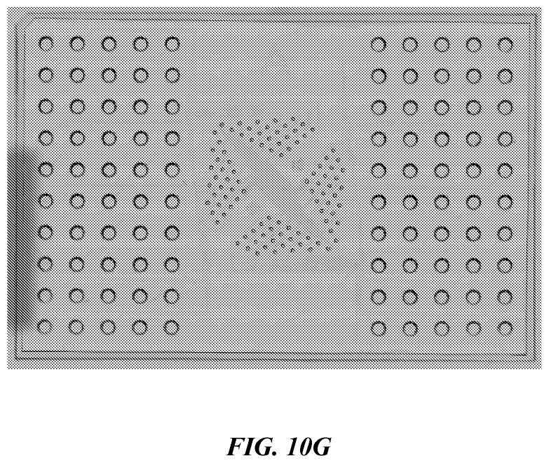

The desirable method to increase the size of the ROI without impairing resolution is to increase the number of channels in the ROI. FIGS. 10A-10G show examples of chips where multiple inlets transverse over the ROI in their separated fashion, then converge into a shared outlet channel. Utilizing the same hole array identified in FIGS. 7A-7C and FIGS. 8A-8C, the number of channels in the ROI were increased from 50 to 96.

FIGS. 10A and 10B show a schematic of one embodiment of a 2-layer common outlet chip (referred to as Chip A). Chip A can be manufactured using the materials and methods described above with respect to the various chips (e.g., with respect to the two-layer chip of FIGS. 7A-7C). FIG. 10A, top layer 1000 of Chip A shows 4 outlets 1002A-D and 96 inlets 1004 (the remaining large ports). In FIG. 10B, bottom layer 1001 of Chip A shows the 4 common outlet vias 1006A-F and numbers 1-96 indicating the vias that correspond to the 96 inlets 1004 of the top layer of Chip A. In Chip A, the inlets corresponding to vias/inlets numbered 1-24 share a common outlet via 1006A in bottom layer 1001 that connects to common outlet 1002A in top layer 1000 (e.g., connect via sample interface channels that traverse the region of interest). Similarly, the inlets corresponding to vias/inlets numbered 25-48 share a common outlet via 1006B in bottom layer 1001 that connects to common outlet 1002B in top layer 1000.

FIGS. 10C and 10D show a schematic of another embodiment of a 2-layer common outlet (referred to as Chip B) for use in conjunction with Chip A. Like Chip A, Chip B employs a common outlet design to allow for 96 sample interface channels. In Chip B, the sample interface channels are arranged perpendicularly relative to the sample interface channels of Chip A. When used in conjunction, Chip A and Chip B allow reagents to be delivered in an intersecting grid for spatial epigenomic analysis.

FIG. 10E shows a zoomed in view of a portion of bottom layer 1003 of Chip B, showing two common outlet vias 1006E and 1006F.

FIG. 10F shows an even more zoomed in view of a portion of bottom layer 1003 of Chip B. In FIG. 10F, multiple sample interface channels 1000A36-1000A39 converge towards a common outlet via, leading to a common outlet. Sample interface channels 1000A36-1000A39 are in fluid connection, respectively, to inlet vias numbered 36-39, as seen in FIG. 10D of the bottom layer of Chip B.

FIG. 10G is an image of assembled Chip A, having both the top and bottom layers.

### Term Definitions

A region of interest is an area of the sample which is assayed by the chip or combination of multiple chips.

The term substrate is a material which supports the sample, such as a PLL coated glass slide or other material such as a gel matrix. Often functionalized with certain coatings (such as poly-L-lysine, PLL, poly-D-lysine, PDL) to enhance their ability to retain mounted tissue sections or other biological material. Depending on the interactions between coatings and reagents, may capture reagent in an undesirable way.

The term sample refers to material to be analyzed by high resolution spatially delivered reagent. Samples are often but not always biological in nature, such as a thin section of a fixed or unfixed tissue block from a variety of species, including but not limited to human, mouse, rat, other primates, other mammals, fish, plants, or nearly any living organism.

The term exposure area refers to the smallest rectangle enclosing chip features which are open to the substrate, thus making the chip vulnerable to dust or contamination, and allowing reagent to interact with the substrate rather than the sample in an undesired manner.

The term active area represents the area covered by the region of interest (usually measured in square millimeters).

The term active area ratio refers to the ratio of active area to exposure area.

The term via refers to a vertical connection between layers of a multi-layer chip allowing liquid and vacuum pressure to communicate between layers without communicating with other channels.

The term blockage describes a state in which liquid reagent is unable to proceed through a microchannel due to lack of applied pressure, such as that caused by debris or other contaminants sealing off a channel or for some other reason.

The term leakage refers to the communication of liquid reagents between neighboring channels. This results in a loss of spatial fidelity of assays conducting using the leaking chip. Sometimes leakages are caused by debris caught underneath the wall between two microchannels, creating undesirable leak paths between the chip and substrate.

The term debris refers to small pieces of material, such as dust or other particulate that, when located on the wrong place on the chip, cause blockages or leakages.

The term reagent/barcode/oligonucleotide: Active ingredients to be delivered to the sample in a spatially encoded manner using the chip. In general, the more of the input reagents that reach the sample the better. Reagents can be lost due to leakage, blockage, or capture by unwanted interaction with the substrate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1.-31. (canceled)

32. A sample analysis chip, comprising:
a sample interface layer, the sample interface layer defining:
a plurality of sample interface channels configured to guide reagents across a region of a sample that is in contact with the sample interface layer, the plurality of sample interface channels comprising a first sample interface channel and a second sample interface channel; and
a loading/unloading layer defining:
a plurality of inlets configured to receive the reagents at an exterior of the sample analysis chip, the plurality of inlets comprising a first inlet and a second inlet;
a plurality of loading channels, comprising a first loading channel being configured to receive a first portion of the reagents from the first inlet and deliver the first portion of the reagents to a first end of the first sample interface channel and a second loading channel configured to receive a second portion of the reagents and deliver the second portion of the reagents to a first end of the second sample interface channel;
a plurality of outlets configured to receive the reagents at the exterior of the sample analysis chip after being guided across the region of the sample, the plurality of outlets comprising a first outlet and a second outlet; and
a plurality of unloading channels, comprising a first unloading channel configured to receive the first portion of the reagents from a second end of the first sample interface channel and guide the first portion of the reagents to the first outlet and a second unloading channel configured to receive the second portion of the reagents from a second end of the second sample interface channel and guide the second portion of the reagents to the second outlet, wherein an active area ratio of the sample analysis chip is greater than 0.25%.

33. The sample analysis chip of claim 32, further comprising a transfer layer disposed between the sample interface layer and the loading/unloading layer.

34. The sample analysis chip of claim 33, wherein the transfer layer defines a plurality of transfer channels on a surface of the transfer layer facing the sample interface layer.

35. The sample analysis chip of claim 34, wherein a cross-sectional area of each of the transfer channels are smaller than a cross-sectional area of each of the loading channels.

36. The sample analysis chip of claim 34, wherein the transfer layer is in direct contact with a first surface of the loading/unloading layer and also in direct contact with a second surface of the sample interface layer.

37. The sample analysis chip of claim 32, further comprising a film layer adhered to and in direct contact with a first surface of the loading/unloading layer and also in direct contact with a second surface of the sample interface layer, wherein the film layer defines one or more pass-through areas allowing reagent travelling through the loading/unloading channels to enter and exit the sample interface channels.

38. The sample analysis chip of claim 32, further comprising:
an inlet via hole connecting the first end of the first sample interface channel to a first end of the first sample interface channel, wherein the inlet via hole is orthogonal to the first loading channel and the first sample interface channel.

39. The sample analysis chip of claim 38, wherein a first portion of the inlet via hole is defined by the loading/unloading layer and a second portion of the inlet via hole is defined by the sample interface layer.

40. The sample analysis chip of claim 38, wherein the inlet via hole is defined entirely by the sample interface layer.

41. The sample analysis chip of claim 32, further comprising a slide clamped directly to the sample interface layer and configured to compress the sample against the sample interface layer.

42. The sample analysis chip of claim 41, wherein the plurality of sample interface channels are defined cooperatively by the sample interface layer and the slide.

43. The sample analysis chip of claim 41, wherein the slide is a glass slide.

44. The sample analysis chip of claim 32, wherein the loading/unloading layer and sample interface layer are both formed from the same type of material.

45. The sample analysis chip of claim 32, wherein the loading/unloading layer and sample interface layer are both formed from polydimethylsiloxane (PDMS) and plasma bonded together.

46. The sample analysis chip of claim 32, wherein the loading/unloading layer and sample interface layer are formed from different types of materials.

47. The sample analysis chip of claim 32, wherein the loading/unloading layer is formed from any of a number of rigid plastic or glass materials and the sample interface layer is formed from an elastomeric material, and the two layers are reversibly or irreversibly bonded together.

48. The sample analysis chip of claim 32, wherein the loading/unloading layer is formed from any of a number of rigid plastic or glass materials and the sample interface layer is formed from polydimethylsiloxane (PDMS), and the two layers are reversibly or irreversibly bonded together.

49. The sample analysis chip of claim 32, wherein the loading/unloading layer is formed from any of a number of rigid plastic or glass materials and the sample interface layer is formed from any of a number of thermoplastic elastomers, and the two layers are reversibly or irreversibly bonded together.

50. The sample analysis chip of claim 32, wherein a width of each channel of the plurality of loading channels is between two and ten times greater than a width of each channel of the plurality of sample interface channels.

51. The sample analysis chip of claim 32, wherein a width of each of the sample interface channels is about between 1 and 100 microns.

52. The sample analysis chip of claim 32, wherein a total area of the plurality of loading channels and the plurality of unloading channels is between four and four thousand times greater than a total area of the plurality of sample interface channels.

53. The sample analysis chip of claim 32, further comprising a vacuum device attached to the plurality of outlets and configured to draw the reagents through the sample analysis chip.

54. The sample analysis chip of claim 32, wherein the plurality of sample interface channels are arranged in parallel in the region of the sample.

55. The sample analysis chip of claim 32, wherein the sample is selected from the group consisting of a biological tissue sample, a biological tissue section, a monolayer of cultured cells and a bio-printed layer of cells.

56. The sample analysis chip of claim 32, wherein the sample is a coated or uncoated glass slide.

57. The sample analysis chip of claim 32, wherein the sample is a coated or uncoated gel matrix.

58. The sample analysis chip of claim 57, wherein the coated or uncoated gel matrix comprises a hydrogel or other polymer gel, with biological tissue embedded in the coated or uncoated gel matrix.

59. The sample analysis chip of claim 32, wherein the first loading channel is disposed at an interface between the loading/unloading layer and the sample interface layer.

60. The sample analysis chip of claim 32, wherein:
the plurality of sample interface channels comprises a third sample interface channel;
the plurality of inlets comprises a third inlet;
the plurality of loading channels comprises a third loading channel that is configured to receive a third portion of the reagents from the third inlet and deliver the third portion of the reagents to a first end of the third sample interface channel; and
the first unloading channel is further configured to receive the third portion of the reagents from a second end of the third sample interface channel and guide the third portion of the reagents to the first outlet.

61. The sample analysis chip of claim 60, wherein:
the plurality of inlets includes at least 48 inlets;
the first outlet is in fluid connection with at least a first set of 24 inlets of the plurality of inlets; and
the second outlet is in fluid connection with at least a second set of 24 inlets of the plurality of inlets, wherein the first set of 24 inlets does not include any inlet of the second set of 24 inlets.

62. The sample analysis chip of claim 32, wherein the active area ratio of the sample analysis chip is greater than 5%.
